(19) United States
(12) Patent Application Publication
(10) Pub. No.: US 2020/0261308 A1
(43) Pub. Date: Aug. 20, 2020

(54) HAND MASSAGER

(71) Applicant: Xiamen Emoka Health Science & Technology Co., Ltd., Fujian (CN)

(72) Inventor: Guanghua ZHOU, Fujian (CN)

(73) Assignee: Xiamen Emoka Health Science & Technology Co., Ltd., Fujian (CN)

(21) Appl. No.: 16/360,002

(22) Filed: Mar. 20, 2019

(30) Foreign Application Priority Data
Feb. 20, 2019 (CN) 201920215443.0

(51) Int. Cl. A61H 23/02

(52) U.S. Cl. CPC A61H 23/02; A61H 2201/1238; A61H 2205/065; A61H 2201/1638; A61H 2201/0207; A61H 2201/0103; A61H 2201/1409; A61H 2205/067

(57) ABSTRACT

The invention discloses an improved hand massager, including a body, an air bag assembly, an air pump, an air valve, a circuit board, a key assembly and a vibrating motor. Four finger stalls are arranged in the body, and both sides of the body are provided with gaps. The air bag assembly is arranged at an upper part and a lower part of a through hole. The invention can massage a palm, a hand back and a finger at the same time and realize all-around hand massage, with good massage effects. The gaps arranged on both sides of the body can be simultaneously applied to left and right hands.

### CROSS-REFERENCE TO RELATED APPLICATION

This application claims the priority benefits of Chinese application serial No. 201920215443.0, filed on Feb. 20, 2019. The entirety of the above-mentioned patent application is hereby incorporated by reference herein and made a part of specification.

### BACKGROUND

### Technical Field

The present invention relates to the technical field of massager, in particular to an improved massager.

### Description of Related Art

With the quick pace of modern life, people's lives are busier and busier, and skills will be declined gradually due to no amateur sport for long term; particularly for the work with fingers, fingers may ache due to long-term working with hands, affecting people's working efficiency, while causing some damage to hands.

Many people like life cultivation and health preservation by massage, and they often pay more attention to massaging their backs or feet, but usually ignore hand massage. In fact, hands are of great influence on health, and they are very sensitive holographic embryos, so massaging both hands is just like massaging the whole body. Fingers are connected with your hearts. Exercising both hands cannot only invigorate the brain, but also can promote overall health. There are over 300 acupuncture points in our hands, and hand massage in idle hours every day can have health efficacy of clearing and activating the channels and collaterals, simply and feasibly. Scientific hand massage can also treat or mitigate diseases on human health, so there are a lot of benefits for human body to massage hands. For this, the hand massager is favored by more and more people based on TCM acupuncture points memorize years of clinical practices, in order to apply selective stimulation to nerve ending by local stimulation, generate local and reflex action, relieve pains on local muscular tissues, joints, mitigate various chronic pains, relax the body, relieve stress and keep the body healthy.

In the prior art, although there are many massage gloves, most of them are only provided with some convex points on the palm, and enhanced stimulation is formed to acupuncture points or muscle through these convex points, in order to improve the massage effect; massage of the whole hands and fingers cannot be met obviously for restricted massage part, single function and poor comfort, and the costs of purchasing a complete set of massage gloves are higher.

### SUMMARY

To overcome the defects of the prior art, the present invention provides an improved hand massager with compact structure, convenient use and good massage effect.

To achieve the above purpose, the solution of the present invention is as follows:

An improved hand massager includes a body, an air bag assembly arranged in the body, an air pump, an air valve, a circuit board, a key assembly and a vibrating motor. The body is provided with a through hole connecting a front end with a rear end, and a front end of the through hole is provided with an opening. A rear end of the through hole is provided with four finger stalls. Both sides of the body are provided with gaps. The air bag assembly comprises a first air bag and a second air bag. The first air bag is arranged at an upper part of the through hole of the body, and the second air bag is arranged at a lower part of the through hole of the body. The air pump is connected with the air valve, and the air valve is connected with the first air bag and the second air bag. The air pump, the air valve, the vibrating motor and the key assembly are connected with the circuit board, respectively.

Furthermore, the first air bag and the second air bag are provided with a first massage part used for messaging fingers and a second massage part used for messaging palms or hand backs, respectively.

Furthermore, a heating piece is also arranged in at least one of the first air bag and the second air bag, and the heating piece is connected to the circuit board by a wire.

Furthermore, at least one silica gel massage piece and/or plastic label is arranged on the first air bag and the second air bag. The silica gel massage piece and/or plastic label of the first air bag arranged at the upper part of the through hole of the body is arranged downwards, and the silica gel massage piece and/or plastic label of the second air bag arranged at the lower part of the through hole of the body is arranged upwards.

Furthermore, the body comprises a hollow outer shell and an inner shell. The hollow outer shell comprises an upper shell and a lower shell mutually buckled with the upper shell. The left and right sides of the hollow outer shell are symmetrically provided with a gap. The inner shell is coordinated in the hollow outer shell. The inner shell is provided with a through hole connecting a front with rear parts. An accommodating space is formed between a periphery of the inner shell and an inner wall of the hollow outer shell. The air bag assembly, the air pump, the air valve, the circuit board, the key assembly and the vibrating motor are arranged in the accommodating space. Two gaps of the inner shell corresponding to the hollow outer shell are provided with convex second gaps.

Furthermore, the accommodating space comprises an upper accommodating space and a lower accommodating space. The upper accommodating space is formed between a top face of the inner shell and a bottom face of the upper shell. The lower accommodating space is formed between a bottom face of the inner shell and a top face of the lower shell. The first air bag is arranged in a center of the upper accommodating space, and the second air bag is arranged in a center of the lower accommodating space.

Furthermore, the body further comprises a finger stall. The finger stall is coordinated in a through hole of the inner shell. A front end and a rear end of the finger stall are provided with PVC boards having openings. The PVC board at the front end is connected with the PVC board at the rear end by a cloth cover. Both sides of the finger stall at one end close to the PVC board at the front end are provided with third gaps which can be stuck in the second gap of the inner shell. Four cloth finger holes are arranged in the opening of the PVC board at the rear end of the finger stall.

Furthermore, the PVC board at the front end and the PVC board at the rear end of the finger stall form a clamping wall, respectively. After the PVC board at the rear end of the finger stall passes through the through hole of the inner shell, its clamping wall is clamped and coordinated at the rear ends of the inner shell and the hollow outer shell. The PVC board at the front end of the finger stall is stuck against and coordinated at the front end of the inner shell, and its clamping wall is clamped and coordinated at the front ends of the inner shell and the hollow outer shell.

Furthermore, the key assembly comprises at least a key and a key fixing plate. A top face of the upper shell of the hollow outer shell is provided with a key configuration part for key installation of the key assembly. Keys are installed on the key configuration part of the upper shell. A bottom face of a key is arranged on the key fixing plate, and the keys are connected with the circuit board.

Furthermore, the top face and bottom face of the inner shell are fixed together with the upper shell and lower shell of the hollow outer shell by mutually coordinated insertion columns and insertion holes.

Upon adoption of the above structure, when the present invention is used, the palm to be massaged will be straightened, and the palm or back can be randomly placed upwards or downwards. Four fingers are correspondingly inserted in four finger stalls. The thumb extends out from the left or right gap of the body. The power supply is started and the massage way is selected. The first massage parts on the first air bag and second air bag can be used for massaging the upper part and the lower part of each finger. The second massage part of the first air bag is used for massaging the upward side of the hand, and the second massage pat of the second air bag is used for massaging the downward side of the hand. The heating piece can generate heating effects so that the hand cannot only be massaged by the first air bag and the second air bag, but also can realize heating massage, with better massage effects. The vibrating motor can realize vibratory massage, so as to further improve massage effects. The silica gel massage piece and/or plastic label can further improve the comfort level of massage. The hand massager of the present invention can massage a palm, a hand back and a finger at the same time and realize all-around hand massage, with diversified massage functions and good massage effects. The gaps arranged on both sides of the body can be simultaneously applied to left and right hands, no matter whether it is palm or back, of convenient use. All massage parts of the present invention are arranged in the body, and the overall structure is compact. The air pump is connected with the first air bag, second air bag and an annular air bag by the air valve, so that users can select massage parts as needed, and the operation is simple.

### BRIEF DESCRIPTION OF THE DRAWINGS

FIG. 1 is a three-dimensional exploded view of the present invention.

FIG. 2 is a three-dimensional outside view of the present invention.

FIG. 3 is a front view of the present invention.

### DESCRIPTION OF THE EMBODIMENTS

To further interpret the technical solution of the present invention, the present invention will be described in detail as below by the specific embodiments.

In the description of the present invention, it should be noted that, the direction or position relations indicated by the terms “center”, “longitudinal”, “transverse”, “upper”, “lower”, “front”, “rear”, “left”, “right”, “vertical”, “horizontal”, “top”, “bottom”, “inner”, “outer”, etc. are the direction or position relations based on the drawings, only to facilitate description of the present invention and simplified description, but not to indicate or imply that the indicated device or element must have a special direction, be made or operated in a special direction, thus it cannot be understood as the restriction to the present invention. In the description of the present invention unless otherwise specified, the “multiple” means two or over two.

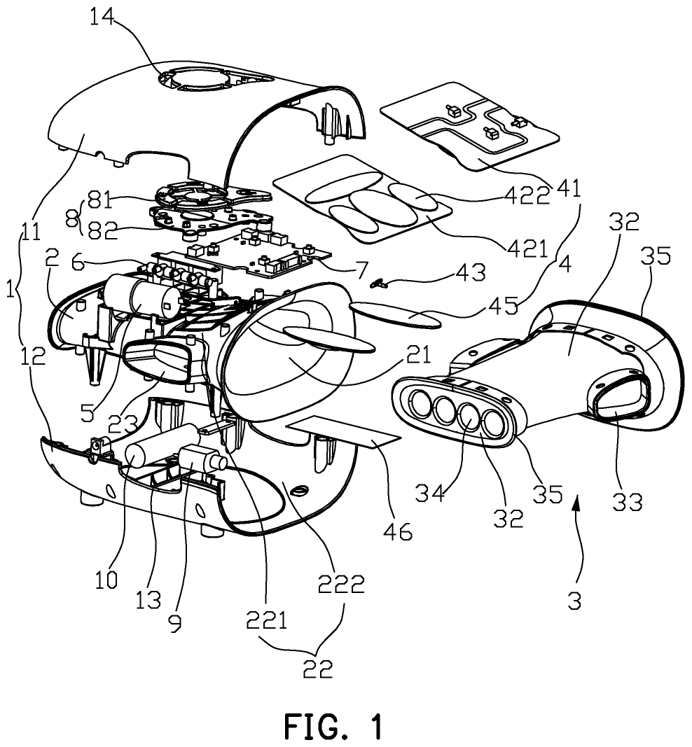

As shown in FIG. 1 to FIG. 3, the present invention discloses an improved hand massager, including a hollow outer shell 1, an inner shell 2, a finger stall 3, an air bag assembly 4, an air pump 5, an air valve 6, a circuit board 7, a key assembly 8 and a vibrating motor 9.

The hollow outer shell 1 comprises an upper shell 11 and a lower shell 12. The upper shell 11 is buckled with the lower shell 12 to form the hollow outer shell 1 connecting the front with the rear parts. The left and right sides of the hollow outer shell 1 are symmetrically provided with gaps 13 for containing thumbs. A top face of the upper shell of the hollow outer shell 1 is provided with a key configuration part 14 for key installation of the key assembly 8.

The inner shell 2 is coordinated in the hollow outer shell 1, and the inner shell 2 is provided with a through hole 21 connecting the front with the rear parts. The top face and bottom face of the inner shell 2 are fixed together with the upper shell 11 and lower shell 12 of the hollow outer shell 1 by mutually coordinated insertion columns and insertion holes. An accommodating space 22 is formed between a periphery of the inner shell 2 and an inner wall of the hollow outer shell 1. The air bag assembly 4, air pump 5, air valve 6, circuit board 7, key assembly 8 and the vibrating motor 9 are arranged in the accommodating space 22. Two gaps 13 of the inner shell 2 corresponding to the hollow outer shell 1 are provided with convex second gaps 23.

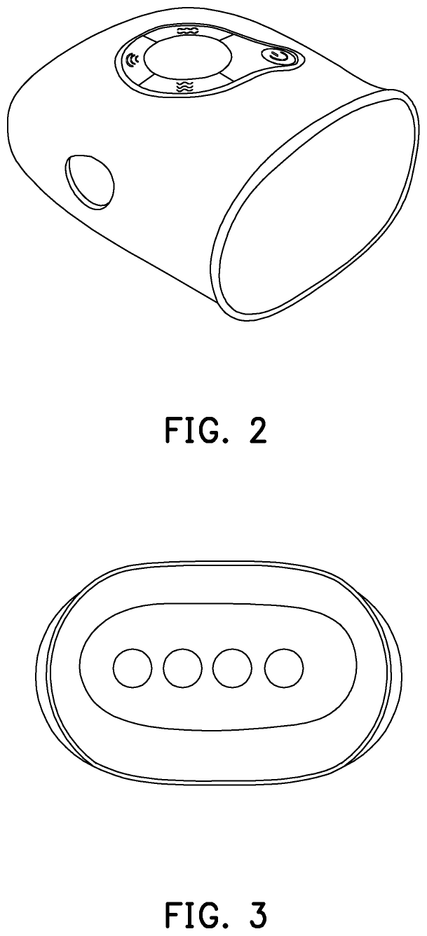

The finger stall 3 is coordinated in a through hole 21 of the inner shell 2. A front end and a rear end of the finger stall 3 are provided with PVC boards having openings 31. The PVC board at the front end is connected with the PVC board at the rear end by a cloth cover 32. Both sides of the finger stall 3 at one end close to the PVC board at the front end are provided with third gaps 33 corresponding to the gap 13 of the hollow outer shell 1 and the second gap 23 of the inner shell 2. The finger stall 3 is provided with four cloth finger stalls 34 in the opening 31 of PVC board at the rear end, and four cloth finger stalls 34 are integrally connected with the cloth cover 32. The PVC board at the front end and the PVC board at the rear end of the finger stall 3 form a clamping wall 35, respectively. After the PVC board at the rear end of the finger stall 3 passes through the through hole 21 of the inner shell 2, its clamping wall 35 is clamped and coordinated at the rear ends of the inner shell 2 and the hollow outer shell 1. The PVC board at the front end of the finger stall 3 is stuck against the front end of the inner shell 2, and its clamping wall 35 is clamped and coordinated at the front ends of the inner shell 2 and the hollow outer shell 1. The third gaps 33 on both sides of the finger stall 3 are coordinated in two second gaps 23 of the inner shell 2, and the two second gaps 23 of the inner shell 2 are coordinated in two gaps 13 of the hollow outer shell 1. The finger stall 3 and the inner shell 2 are assembled with the hollow outer shell 1 to form the body of the hand massager as shown in FIG. 2.

The air bag assembly 4 comprises a first air bag 41 and a second air bag 42, and the accommodating space 22 formed between the periphery of the inner shell 2 and the inner wall of the hollow outer shell 1 comprises an upper accommodating space 221 and a lower accommodating space 222. The upper accommodating space 221 is formed between a top face of the inner shell 2 and a bottom face of the upper shell 11. The lower accommodating space 222 is formed between a bottom face of the inner shell 2 and a top face of the lower shell 12. The first air bag 41 is arranged in the center of the upper accommodating space 221, and the second air bag 42 is arranged in the center of the lower accommodating space 222. The end of the first air bag 41 close to the finger stall 34 is provided with a massage part used for massaging fingers, and the first air bag 41 is provided with a second massage part used for massaging a palm or back at a front end of the first massage part 411. As such, the end of the second air bag 42 close to the finger stall 34 is provided with a first massage part 421 used for massaging fingers, and the second air bag 42 is provided with a second massage part 422 used for massaging a palm or fingers at a front end of the first massage part.

The first air bag 41 and the second air bag 42 are connected to the air valve 6 by a T joint 43. The air valve 6 is connected with the air pump 5. The air pump 5 and the air valve 6 are connected with the circuit board 7, respectively. At least one silica gel massage piece 44 and/or plastic label 45 can also be arranged on the first air bag 41 and the second air bag 42. The silica gel massage piece 44 and/or plastic label 45 of the first air bag 41 arranged on the upper accommodating space 221 are arranged downwards, and the silica gel massage piece 44 and/or plastic label 45 of the second air bag 42 arranged on the lower accommodating space 222 is arranged upwards. A heating piece 46 is also arranged in at least one of the first air bag 41 and the second air bag 42, and the heating piece 46 is connected to the circuit board 7 by a wire.

The key assembly 8 comprises at least a key 81 and a key fixing plate 82. The key 81 is installed on the key configuration part 14 of the upper shell 11, and a bottom part of the key 81 is arranged on the key fixing plate 82. The key 81 is connected with the circuit board 7. The air pump 5, air valve 6, key fixing plate 82, circuit board 7 and the first air bag 41 are arranged in the upper accommodating space 221, and the vibrating motor 9 is arranged in the lower accommodating space 222. The vibrating motor 9 is connected with the circuit board 7, and the lower accommodating space 222 is also internally provided with a driving power 10 which may be aluminum battery, battery pack or power plug, etc. The driving power 10 provides a power source for each electric device.

When the present invention is used, the palm to be massaged will be straightened, and the palm or back can be randomly placed upwards or downwards. Fingers are inserted from the front opening 31 of the finger stall 3 to the rear end of the finger stall 3. Four fingers are correspondingly inserted in four finger stalls 34 at the rear end of the finger stall 3. The thumb extends out from the third gap 33 on the left or right. The power supply is started and the massage way is selected by the key 81. The first air bag 41 is used for massaging the upward side of the hand (including fingers and palm or back), and the second air bag 42 is used for massaging the downward side of the hand (including fingers and back or palm); and the second massage pat of the second air bag is used for massaging the downward side of the hand. The heating piece 46 can generate heating effects so that the hand cannot only be massaged by the first air bag 41 and the second air bag 42, but also can realize heating massage, with better massage effects. The vibrating motor 9 can realize vibratory massage, so as to further improve massage effects. The silica gel massage piece 44 and/or plastic label 45 can further improve the comfort level of massage. The hand massager of the present invention can massage a palm, a hand back and a finger at the same time and realize all-around hand massage, with diversified massage functions and good massage effects. The gaps arranged on both sides of the body can be simultaneously applied to left and right hands, no matter whether it is palm or back, of convenient use. All massage parts of the present invention are arranged in the body, and the overall structure is compact. The air pump 5 is connected with the first air bag 41, second air bag 42 and an annular air bag 34 by the air valve 6, so that users can select massage parts as needed, and the operation is simple.

The above embodiments and drawings do not define product forms and styles of the present invention, and any appropriate change or modification made by a common person skilled in the art shall be deemed not to depart from the patent scope of the present invention.

What is claimed is:

1. An improved hand massager, comprising a body, an air bag assembly arranged in the body, an air pump, an air valve, a circuit board, a key assembly and a vibrating motor, wherein the body is provided with a through hole connecting a front end with a rear end, and a front end of the through hole is provided with an opening; a rear end of the through hole is provided with four finger stalls; both sides of the body are provided with gaps; the air bag assembly comprises a first air bag and a second air bag; the first air bag is arranged at an upper part of the through hole of the body, and the second air bag is arranged at a lower part of the through hole of the body; the air pump is connected with the air valve, and the air valve is connected with the first air bag and the second air bag; the air pump, the air valve, the vibrating motor and the key assembly are connected with the circuit board respectively.

2. The improved hand massager according to claim 1, wherein the first air bag and the second air bag are provided with a first massage part used for messaging fingers and a second massage part used for messaging palms or hand backs, respectively.

3. The improved hand massager according to claim 2, wherein a heating piece is also arranged in at least one of the first air bag and the second air bag, and the heating piece is connected to the circuit board by a wire.

4. The improved hand massager according to claim 2, wherein at least one silica gel massage piece and/or plastic label is arranged on the first air bag and the second air bag; the silica gel massage piece and/or plastic label of the first air bag arranged at the upper part of the through hole of the body is arranged downwards, and the silica gel massage piece and/or plastic label of the second air bag arranged at the lower part of the through hole of the body is arranged upwards.

5. The improved hand massager according to claim 1, wherein the body comprises a hollow outer shell and an inner shell; the hollow outer shell comprises an upper shell and a lower shell mutually buckled with the upper shell; the left and right sides of the hollow outer shell are symmetrically provided with a gap; the inner shell is coordinated in the hollow outer shell; the inner shell is provided with a through hole connecting a front with rear parts; an accommodating space is formed between a periphery of the inner shell and an inner wall of the hollow outer shell; the air bag assembly, the air pump, the air valve, the circuit board, the key assembly and the vibrating motor are arranged in the accommodating space; two gaps of the inner shell corresponding to the hollow outer shell are provided with convex second gaps.

6. The improved hand massager according to claim 5, wherein the accommodating space comprises an upper accommodating space and a lower accommodating space; the upper accommodating space is formed between a top face of the inner shell and a bottom face of the upper shell; the lower accommodating space is formed between a bottom face of the inner shell and a top face of the lower shell; the first air bag is arranged in a center of the upper accommodating space, and the second air bag is arranged in a center of the lower accommodating space.

7. The improved hand massager according to claim 5, wherein the body further comprises a finger stall; the finger stall is coordinated in a through hole of the inner shell; a front end and a rear end of the finger stall are provided with PVC boards having openings; the PVC board at the front end is connected with the PVC board at the rear end by a cloth cover; both sides of the finger stall at one end close to the PVC board at the front end are provided with third gaps which can be stuck in the second gap of the inner shell; four cloth finger holes are arranged in the opening of the PVC board at the rear end of the finger stall.

8. The improved hand massager according to claim 7, wherein the PVC board at the front end and the PVC board at the rear end of the finger stall form a clamping wall, respectively; after the PVC board at the rear end of the finger stall passes through the through hole of the inner shell, its clamping wall is clamped and coordinated at rear ends of the inner shell and the hollow outer shell; the PVC board at the front end of the finger stall is stuck against and coordinated at the front end of the inner shell, and its clamping wall is clamped and coordinated at the front ends of the inner shell and the hollow outer shell.

9. The improved hand massager according to claim 1, wherein the key assembly comprises at least a key and a key fixing plate; a top face of an upper shell of a hollow outer shell is provided with a key configuration part for key installation of the key assembly; keys are installed on the key configuration part of the upper shell; a bottom face of the key is arranged on the key fixing plate, and the keys are connected with the circuit board.

10. The improved hand massager according to claim 4, wherein a top face and a bottom face of an inner shell are fixed together with an upper shell and a lower shell of a hollow outer shell by mutually coordinated insertion columns and insertion holes.
